(19) United States
(12) Patent Application Publication
(10) Pub. No.: US 2005/0119028 A1
(43) Pub. Date: Jun. 2, 2005

(54) Miniature subscriber terminal and subscriber terminal set for radio system

(76) Inventor: Susanna Paasovaara, Oulu (FI)

Correspondence Address: CRAWFORD MAUNU PLLC, 1270 NORTHLAND DRIVE, SUITE 390, ST. PAUL, MN, 55120, US

(21) Appl. No.: 10/964,233

(22) Filed: Oct. 13, 2004

(30) Foreign Application Priority Data
Oct. 22, 2003 (FI) 20031547

(51) Int. Cl. H04Q 7/20

(52) U.S. Cl. 455/558; 455/425; 455/556.1

(57) ABSTRACT

There is provided a miniature subscriber terminal comprising a control unit, a radio transceiver, a processing unit for a subscriber identity module to be placed therein, and a memory. The miniature subscriber terminal further comprises a mechanical interface for coupling the miniature subscriber terminal to a second terminal, whereby the miniature subscriber terminal and the second terminal, when coupled, form an integrated whole, and a data transmission interface connected to the control unit for providing a data transmission connection to the second terminal, and the control unit is configured to receive and process commands from the second terminal via the data transmission interface, the commands including at least one of the following: a SIM card processing command, a command concerning the user's private data stored in the memory, a call processing command, a message processing command.

### FIELD

The invention relates to a miniature subscriber terminal for a radio system and a subscriber terminal set for a radio system.

### BACKGROUND

The use of radio system subscriber terminals, for instance mobile stations, has become more and more common during the past few years. Many users may have more than one mobile station at their disposal. Few users, however, have several mobile subscriptions. So, as the user changes a mobile station, he or she must remember to change the SIM (Subscriber Identity Module) card from one mobile station to another. The user's private data stored in the memory of one mobile station will not be transferred to the memory of the other mobile station, however. The user's private data includes, for instance, received text messages, various mobile station settings, and game saves, for instance, in such mobile stations that support the playing of electronic games.

Currently the user is thus obliged to transfer the SIM card from one mobile station to another if he or she wishes to use different mobile stations. Moreover, it may be necessary to enter the user's private data manually into the currently used phone through the user interface of the mobile station. For instance, manual entering of already transmitted or received text messages is not reasonable. It may not even be possible to transfer some of the user's private data, such as game saves, from one mobile station to another using manual entering.

### BRIEF DESCRIPTION

The object of the invention is to provide an improved miniature subscriber terminal and an improved subscriber terminal set for a radio system.

One aspect of the invention relates to a miniature radio-system subscriber terminal comprising a control unit for controlling and monitoring operations, a radio transceiver connected to the control unit for establishing a connection to a network part of the radio system, a processing unit connected to the control unit for a SIM card to be placed therein, and a memory for storing the user's private data. The miniature subscriber terminal also comprises a mechanical interface for coupling the miniature subscriber terminal to a second terminal, whereby the miniature subscriber terminal and the second terminal, when coupled, form an integrated whole, and a data transmission interface connected to the control unit for connecting the miniature subscriber terminal to the second terminal over a data transmission connection, and the control unit is configured to receive and process commands from the second terminal through the data transmission interface, the commands including at least one of the following: a SIM card processing command, a command concerning the user's private data stored in the memory, a call processing command, a message processing command.

One aspect of the invention relates to a radio-system subscriber terminal set comprising a miniature subscriber terminal and a second terminal, the miniature subscriber terminal comprising a control unit for controlling and monitoring operations, a radio transceiver connected to the control unit for establishing a connection to a network part of the radio system, a processing unit connected to the control unit for a SIM card to be placed therein, and a memory for storing the user's private data, a mechanical interface for coupling the miniature subscriber terminal to a second terminal, whereby the miniature subscriber terminal and the second terminal, when coupled, form an integrated whole, and a data transmission interface for connecting the miniature subscriber terminal to the second terminal over a data transmission connection, and the control unit is configured to receive and process commands from the second terminal through the data transmission interface, the commands including at least one of the following: a SIM card processing command, a command concerning the user's private data stored in the memory, a call processing command, a message processing command.

One aspect of the invention relates to a miniature subscriber terminal for a radio system, comprising control means for controlling and monitoring operations, radio means for establishing a connection to a network part of the radio system, identity module means for processing a subscriber identity module and storing means for storing the user's private data. The miniature subscriber terminal also comprises connecting means for coupling the miniature subscriber terminal to a second terminal, whereby the miniature subscriber terminal and the second terminal, when coupled, form a integrated whole, and data transmission means for establishing a data transmission connection to the second terminal, and the control means receive and process commands from the second terminal through the data transmission means, the commands including at least one of the following: a SIM card processing command, a command concerning the user's private data stored in the memory, a call processing command, a message processing command.

Several advantages are achieved with the invention. Because the commissioned miniature subscriber terminal includes a SIM card and a memory for user's private data, the user may readily have several other terminals at his or her disposal. The miniature subscriber terminal is conveniently integrated into a set and terminals specialising in different functions can serve as a part of the set. Cumbersome entering of data and changing of the SIM card from one terminal to another will thus be avoided.

### LIST OF FIGURES

The invention will now be described in greater detail in connection with preferred embodiments, with reference to the attached drawings, wherein

FIG. 1 is a simplified block diagram of the structure of a subscriber terminal set for a radio system, the set consisting of a miniature subscriber terminal and a second terminal;

FIG. 2 illustrates data transmission between the miniature subscriber terminal and a separate data processor;

FIG. 3 illustrates a possible appearance of the subscriber terminal set;

FIG. 4 shows the miniature subscriber terminal secured to a wristband; and

FIG. 5 shows the miniature subscriber terminal secured to a necklace.

### DESCRIPTION OF THE EMBODIMENTS

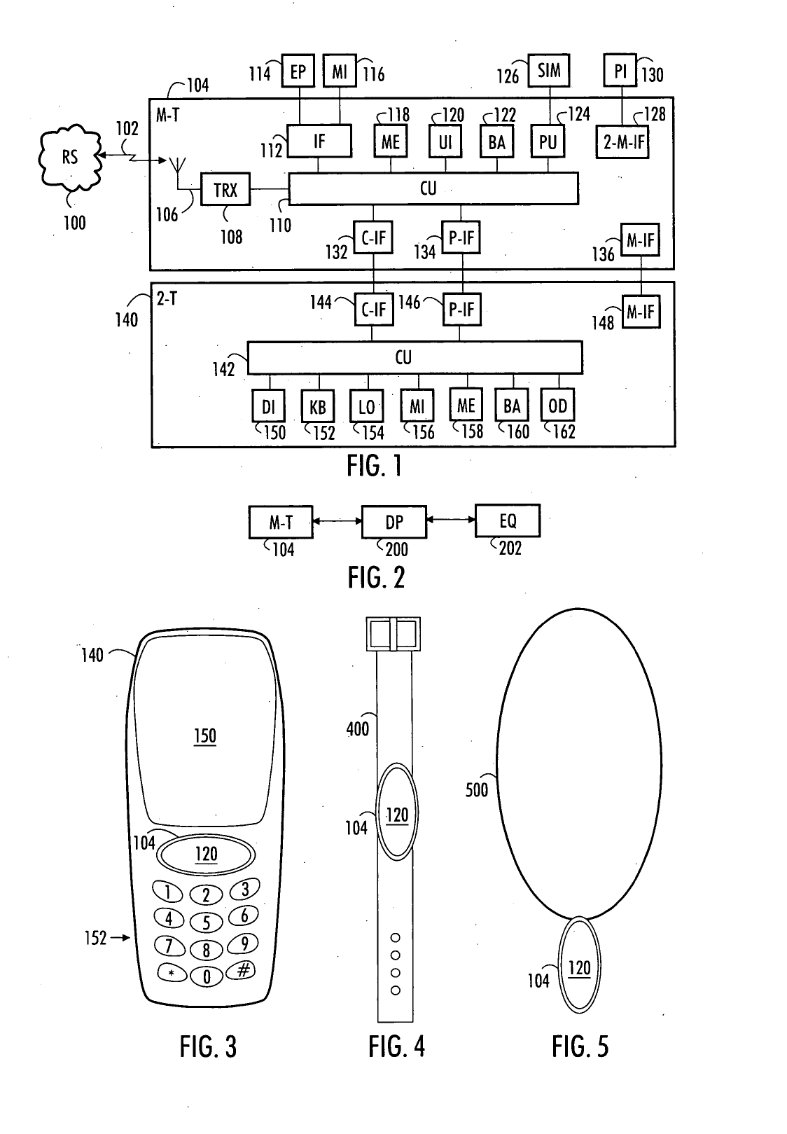

With reference to FIG. 1, the structure of a radio system subscriber terminal set will now be described, starting with the structure of a miniature subscriber terminal 104 belonging to the set. The subscriber terminal can also be called a mobile station or a user equipment, for instance. In this document the mere terminal refers to a device that does not include a subscriber identity module and not necessarily even a radio transceiver. For instance, in UMTS (Universal Mobile Telecommunications System) the user equipment consists of two parts: a mobile equipment and a UMTS subscriber identity module (USIM). According to the terminology used in the present document the user equipment is called a subscriber terminal and the mobile device is called a terminal.

The miniature subscriber terminal 104 comprises a control unit 110 for controlling and monitoring operations. In addition the control unit 110 includes application programs, for instance, for radio signal processing and user interface management. Currently, the control unit 110 is generally implemented as a processor with software, but various hardware solutions are also feasible, for instance, a circuit constructed of separate logic components, or one or more application-specific integrated circuits (ASIC). If necessary, there may be more than one processor. A hybrid of these solutions is also feasible. In the selection of the implementation method, a person skilled in the art will naturally consider the requirements set for the size and power consumption of the device, the required processing capacity, manufacturing costs and production volumes.

The miniature subscriber terminal 104 further comprises a radio transceiver 108 having an antenna 106 and connected to the control unit for establishing a connection 102 to a network part 100 of the radio system. The radio transceiver 108 is, for instance, a prior art mobile station transceiver, which operates, for instance, in the GSM (Global System for Mobile Communications) system, the GPRS (General Packet Radio Service) system, the UMTS (Universal Mobile Telecommunications System) or in another mobile system, cellular radio system, or in more general terms, in any radio system.

The miniature subscriber terminal 104 also comprises a processing unit 124 connected to the control unit 110 for the subscriber identity module (SIM) 126 to be placed therein and a memory 118 in which the user's private data is stored. The processing unit 124 is, for instance, a read/write device, with which it is possible to process the SIM card, which is to be inserted in the read/write device and which is now commonly used by the mobile phone operators. The processing unit 124 can be implemented by any known technology for processing the subscriber identity module 126. The subscriber identity module 126 contains security-related information, other subscriber-related information and algorithms. The memory 118 can be implemented by any known technology that suits for a small-sized portable device. Examples of memories suitable for the purpose include EEPROM (Electrically Erasable Programmable Read-Only Memory) and flash memories.

The user's private data stored in the memory 118 may include, for instance, the following: personal phone book, terminal settings, game saves, game settings, calendar entry, note, message, image, ringing tone, text file, notepad, shopping list.

In one embodiment the user's private data stored in the memory 118 also includes tagged parts. In that case the control unit 110 is configured to process memory 118 by referring to tags. The tags can be implemented using XML (Extensible Markup Language), for instance.

The miniature subscriber terminal 104 also comprises two different interfaces for coupling the miniature subscriber terminal 104 to a second terminal 140: a mechanical interface 136 and a data transmission interface 132.

The mechanical interface 136 allows the miniature subscriber terminal 104 to be coupled to a second terminal 140, whereby the miniature subscriber terminal 104 and the second terminal 140 form, when coupled, an integrated whole. The second terminal 140 also comprises a control unit 142. The mechanical interface 136 can be implemented by any known manner to couple two light portable items together. One manner to implement the coupling of the devices 104, 140 includes that in the manufacturing stage the casings of both the miniature subscriber terminal 104 and the second terminal 140 are provided with compatible, interlocking connectors 136, 148. FIG. 3 illustrates one example of feasible appearance of a subscriber terminal set: a miniature subscriber terminal 104 is connected to a second terminal 140 and they form an integrated whole. The second terminal 140 can be larger than the miniature subscriber terminal 104, as described, whereby the use of the subscriber terminal set can be easier than the use of the mere miniature subscriber terminal 104. The second terminal 140, however, can be of the same size as or smaller than the miniature subscriber terminal 104.

The data transmission interface 132 connected to the control unit 110 allows the miniature subscriber terminal 104 to communicate over a data transmission connection with the second terminal 140. The data transmission connection 132 can be implemented by any prior art method suitable for the purpose. These methods include wired and wireless technologies, for instance, the use of serial and parallel connectors, or a short-range radio trans-transceiver, such as Bluetooth®. In one embodiment the miniature subscriber terminal 104 includes a short-range radio transceiver 132 and correspondingly the second terminal 140 also includes a short-range radio transceiver 144.

The control unit 110 is configured to receive and process commands from the second terminal 140 over the data transmission interface 132. The commands comprise at least one of the following: a SIM card 126 processing command, a command concerning user's private data stored in the memory 118, a call processing command, a message processing command. The configuration of the control unit 110 forms structural entities that can be implemented, for instance, as program modules, i.e. by a programming language, such as the C programming language, C++ programming language, computer language or by an assembler, which is stored as a runnable version in a memory in connection with the processor and run on the processor. Instead of translatable programming languages, interpretable programming languages may naturally also be used, provided that they satisfy the required processing rate and capacity. When the control unit 110 is implemented as an ASIC, the structural entities are ASIC blocks.

The subscriber terminal set is such that the miniature subscriber terminal 104 and the second terminal 140 constituting the set can be interconnected both mechanically and through a data transmission interface. The miniature subscriber terminal 104 can be employed as such for calls and other communication, for instance, for receiving text messages by using SMS (Short Message Service). In addition, the subscriber identity module 126 can be inserted in the miniature subscriber terminal 104 and user's private data can be stored in the memory 118 thereof. The miniature subscriber terminal 104 thus serves as the carrier of both the subscriber identity module and the user's private data. FIGS. 4 and 5 illustrate embodiments, in which the miniature subscriber terminal 104 comprises a second mechanical interface 128 for securing the miniature subscriber terminal 104 to a personal item 130 of the user. In FIG. 4 the personal item 130 is a wristband 400 and in FIG. 5 a necklace 500. In this manner the user can easily carry the miniature subscriber terminal 104 about him or her. It is also possible to include other useful functions in the miniature subscriber terminal 104: it may comprise a clock and/or a calendar, which enables time display and performance of various wake-up and reminder alarms.

In one embodiment the user interface 120 of the miniature subscriber terminal 104 has more restricted functionality than the user interface of the second terminal. In that case, when the miniature subscriber terminal 104 is connected to the second terminal 140, it will be possible to use the more versatile and possibly more user-friendly user interface of the second terminal 140, for instance, for processing calls and messages, for processing the subscriber identity module 126 and for processing the user's private data stored in the memory 118.

FIG. 2 shows one convenient way to implement a small-sized user interface for the miniature subscriber terminal 104: the miniature subscriber terminal 104 can be provided with a relatively large touch screen 120 as compared with the terminal's overall size. The touch screen 120 can be implemented in prior art manners. One manner to implement the touch screen 120 is to set a touch pad on top and a display suitable for the purpose there- beneath. The touch pad can be implemented by prior art solutions, which can be based on capacitive or resistive sensors, for instance. As the user touches the touch pad with his finger, for instance, the touched point and usually also the tactile force can be determined. The display can be implemented by prior art solutions, for instance, as a liquid crystal display (LCD), a plasma display or a thin-film transistor display (TFT). The touch screen can be provided with a virtual keyboard by which the user can give commands to the miniature subscriber terminal 104. By placing a tactile feedback unit under the display the keyboard can also be made such that it gives tactile feedback. The feedback unit providing tactile feedback can be implemented by prior art solutions, for instance, by a piezoelectric element or a linear vibrator based on a solenoid. The feedback unit generates mechanical movement, which the user can sense through touch. The frequency, amplitude and duration of the movement can be controlled. The movement can be sensed as trembling and vibration, for instance. The movement can simulate the click resulting from pressing a key of a mechanical keyboard, for instance. In the most complex case the tactile feedback may imitate the texture of a surface. The use of advanced technology like this in the implementation of the user interface 120 of the miniature subscriber terminal 104 makes it possible to achieve a miniature subscriber terminal 104, by which text messages can be entered and transmitted relatively easily, despite the small size of the device.

In order to reduce the size of the miniature subscriber terminal 104 it can be constructed such that it does not include a microphone nor a loudspeaker, but only an interface for connecting a separate earpiece 114 and a separate microphone 116. Apart from the reduced device size, there is achieved an additional advantage that it will be easier to use the separate earpiece 114 and microphone 116 than the loudspeaker and microphone of a very small device. The interface 112 can be implemented by prior art methods. The earpiece 114 and the microphone 116 can be connected to the miniature subscriber terminal 104 using a wired method or the Bluetooth®, for example.

In the manner shown in FIG. 1, and also partly in FIG. 2, the more versatile user interface of the second device 140 may also include a display 150, a keyboard 152, a loudspeaker 154 and a microphone 156. These user interface parts can be implemented by prior art solutions. The second terminal 140 may also include a memory 158 for storing user's private data. When the user wishes to transfer data between different terminals, he or she may transfer user's private data from memory 158 to memory 118 and further to a memory of a third terminal.

Apart from the user interface, the second terminal 140 can be more versatile than the miniature terminal 104 also in other respects. The second terminal 140 may thus include at least one of the following accessories 162: a digital camera, video game controls, a multimedia processor, a reproducer for stored audio information and/or stored visual information, a web browser, image processing software, a calendar, a positioning receiver, a PDA (Personal Digital Assistant) device, a computer game device. Thus, one optional scenario is that the user possesses one miniature subscriber terminal 104, which includes the most important elements, i.e. the subscriber identity module 126 and the memory 118 containing user's private data. In addition, the user may have a plurality of various optimized second terminals 140 for various purposes: e.g. one game machine, one camera, one player, etc.

In one embodiment the second terminal 140 does not comprise a transceiver for establishing a connection to the network part 100 of the radio system, the transceiver being not necessarily needed, because the miniature subscriber terminal 104 comprises the radio transceiver 108. In one embodiment the second terminal 140 does not comprise a processing unit for the subscriber identity module to be placed therein, the processing unit being not necessarily needed, because the miniature subscriber terminal 104 comprises the processing unit 124. These two embodiments make it possible to reduce the manufacturing costs of the second terminal 140. Moreover, the weight of the device is naturally reduced, and likewise, the size can be reduced if so desired.

In one embodiment, the power source 122, typically a chargeable battery, of the miniature subscriber terminal 104 has a shorter operating time than the power source 160 of the second terminal 140. Thus, the miniature subscriber terminal 104 of this embodiment is only intended for occasional use; for use of longer duration it should be coupled to the second terminal 140. In one embodiment the miniature subscriber terminal 104 has an interface 134 for input supply current from the second terminal 140. Correspondingly, the second terminal 140 must then have an interface 146 for output supply current. The supply current interfaces 134, 146 can also be disposed in connection with a wired data transmission interface 132, 144, whereby supply current can be conducted using some pins. The supply current can also be provided by other suitable prior art methods.

In one embodiment the control unit 110 is also configured to perform authentication prior to receiving commands from the second terminal 140. The authentication can be performed in known manners, for instance, such that the user must enter a PIN (Personal Identification Number) code using the keyboard 152 of the second terminal 140. This embodiment improves data security.

FIG. 2 illustrates an embodiment, in which the miniature subscriber terminal 104 is used for data transmission with a separate data processor 200. The miniature subscriber terminal 104 is also connectable via a data transmission interface 132 to communicate over a data transmission connection with the separate data processor 200. The control unit 110 is further configured to receive the user's private data from the separate data processor 200 and to transmit the user's private data to the separate data processor 200. In addition to the above-mentioned data types, the user's private data may then include the following data: health data of the user, exercise data of the user, beauty parlour data of the user, appointment data concerning services booked by the user. In the manner described in FIG. 2, the data processor 200 may also have a connection to another device 202. The other device 202 can be, for instance, a rowing machine at a gym, and thus the duration and strain level of the user's exercise can be loaded from the miniature subscriber terminal 104 through the data processor 200 into the rowing machine. Also feedback information from the exercise can be loaded from the rowing machine 202 into the miniature subscriber terminal 104.

Even though the invention is described above with reference to an example in accordance with the attached drawings, it is apparent that the invention is not restricted thereto but it may be modified in various ways within the scope of the accompanying claims.

1. A miniature radio-system subscriber terminal comprising:
a control unit for controlling and monitoring operations,
a radio transceiver connected to the control unit for establishing a connection to a network part of the radio system,
a processing unit connected to the control unit for a SIM card to be placed therein, and
a memory for storing the user's private data,
wherein the miniature subscriber terminal also comprises
a mechanical interface for coupling the miniature subscriber terminal to a second terminal, whereby the miniature subscriber terminal and the second terminal, when coupled, form an integrated whole, and
a data transmission interface connected to the control unit for connecting the miniature subscriber terminal to the second terminal over a data transmission connection,
and the control unit is configured to receive and process commands from the second terminal through the data transmission interface, the commands including at least one of the following: a SIM card processing command, a command concerning the user's private data stored in the memory, a call processing command, a message processing command.

2. A miniature subscriber terminal as claimed in claim 1, wherein the user's private data stored in the memory includes at least one of the following: personal phone book, terminal settings, game saves, game settings, calendar entry, note, message, image, ringing tone, text file, notepad, shopping list.

3. A miniature subscriber terminal as claimed in claim 1, wherein the user's private data stored in the memory also includes tagged parts and the control unit is further configured to process memory by referring to tags.

4. A miniature subscriber terminal as claimed in claim 1, wherein the miniature subscriber terminal further comprises a power source having a shorter operating time than the power source of the second terminal.

5. A miniature subscriber terminal as claimed in claim 1, wherein the control unit is further configured to perform authentication prior to receiving commands from the second terminal.

6. A miniature subscriber terminal as claimed in claim 1, wherein the miniature subscriber terminal further comprises a user interface whose functionality is more restricted than that of the second terminal.

7. A miniature subscriber terminal as claimed in claim 1, wherein the miniature subscriber terminal also comprises a touch screen.

8. A miniature subscriber terminal as claimed in claim 1, wherein the miniature subscriber terminal also comprises an interface for coupling a separate earpiece and a separate microphone.

9. A miniature subscriber terminal as claimed in claim 1, wherein the miniature subscriber terminal further comprises a second mechanical interface for securing the miniature subscriber terminal to a wristband, a necklace or another personal item of the user.

10. A miniature subscriber terminal as claimed in claim 1, wherein the miniature subscriber terminal further comprises an interface for receiving input supply current from the second terminal.

11. A miniature subscriber terminal as claimed in claim 1, wherein the miniature subscriber terminal is also connectable via a data transmission interface to communicate over a data transmission connection with the separate data processor and the control unit is further configured to receive the user's private data from the separate data processor and to transmit the user's private data to the separate data processor and the user's private data includes at least one of the following: health data of the user, exercise data of the user, beauty parlour data of the user, appointment data concerning services booked by the user.

12. A subscriber terminal set for a radio system, comprising a miniature subscriber terminal and a second terminal, the miniature subscriber terminal comprising:
a control unit for controlling and monitoring operations,
a radio transceiver connected to the control unit for establishing a connection to a network part of the radio system,
a processing unit connected to the control unit for a SIM card to be placed therein,
a memory for storing the user's private data,
a mechanical interface for coupling the miniature subscriber terminal to the second terminal, whereby the miniature subscriber terminal and the second terminal, when coupled, form an integrated whole, and
a data transmission interface connected to the control unit for connecting the miniature subscriber terminal to the second terminal over a data transmission connection,
and the control unit is configured to receive and process commands from the second terminal through the data transmission interface, the commands including at least one of the following: a SIM card processing command, a command concerning the user's private data stored in the memory, a call processing command, a message processing command.

13. A subscriber terminal set as claimed in claim 12, wherein the user's private data stored in the memory includes at least one of the following: personal phone book, terminal settings, game settings, game saves, calendar entry, note, message, image, ringing tone, text file, notepad, shopping list.

14. A subscriber terminal set as claimed in claim 12, wherein the user's private data stored in the memory also includes tagged parts and the control unit is further configured to process memory by referring to tags.

15. A subscriber terminal set as claimed in claim 12, wherein the miniature subscriber terminal further comprises a power source having a shorter operating time than the power source of the second terminal.

16. A subscriber terminal set as claimed in claim 12, wherein the control unit is further configured to perform authentication prior to receiving commands from the second terminal.

17. A subscriber terminal set as claimed in claim 12, wherein the miniature subscriber terminal further comprises a user interface whose functionality is more restricted than that of the second terminal.

18. A subscriber terminal set as claimed in claim 12, wherein the miniature subscriber terminal also comprises a touch screen.

19. A subscriber terminal set as claimed in claim 12, wherein the miniature subscriber terminal also comprises an interface for coupling a separate earpiece and a separate microphone.

20. A subscriber terminal set as claimed in claim 12, wherein the miniature subscriber terminal further comprises a second mechanical interface for securing the miniature subscriber terminal to a wristband, a necklace or another personal item of the user.

21. A subscriber terminal set as claimed in claim 12, wherein the miniature subscriber terminal further comprises an interface for receiving input supply current from the second terminal.

22. A subscriber terminal set as claimed in claim 12, wherein the miniature subscriber terminal is also connectable via a data transmission interface to communicate over a data transmission connection with the separate data processor and the control unit is further configured to receive the user's private data from the separate data processor and to transmit the user's private data to the separate data processor and the user's private data includes at least one of the following: health data of the user, exercise data of the user, beauty parlour data of the user, appointment data concerning services booked by the user.

23. A subscriber terminal set as claimed in claim 12, wherein the second terminal comprises at least one of the following accessories: digital camera, digital video camera, video game controls, multimedia processor, reproducer for stored audio information and/or stored visual information, web browser, image processing software, calendar, positioning receiver, PDA (Personal Digital Assistant) device, computer game device.

24. A subscriber terminal set as claimed in claim 12, wherein the second terminal comprises a display, a keyboard, a loudspeaker and a microphone.

25. A subscriber terminal set as claimed in claim 12, wherein the second terminal does not include a radio transceiver for establishing a connection to the network part of the radio system.

26. A subscriber terminal set as claimed in claim 12, wherein the second terminal does not include a processing unit for the subscriber identity module to be placed therein.

27. A miniature subscriber terminal for a radio system, comprising:
control means for controlling and monitoring the operations;
radio means for establishing a connection to a network part of the radio system;
subscriber identity module means for processing the subscriber identity module, and
storing means for storing the user's private data,
wherein the miniature subscriber terminal further comprises
connecting means for coupling the miniature subscriber terminal to a second terminal, whereby the miniature subscriber terminal and the second terminal, when coupled, form an integrated whole, and
data transmission means for establishing a data transmission connection to the second terminal,
and the control means receive and process commands from the second terminal via the data transmission means, the commands comprising at least one of the following: a SIM card processing command, a command concerning the user's private data stored in the memory, a call processing command, a message processing command.

28. A miniature subscriber terminal as claimed in claim 27, wherein the user's private data stored in the storing means includes at least one of the following: personal phone book, terminal settings, game saves, game settings, calendar entry, note, message, image, ringing tone, text file, notepad, shopping list.

29. A miniature subscriber terminal as claimed in claim 27, wherein the miniature subscriber terminal further comprises second connecting means for securing the miniature subscriber terminal to a wristband, a necklace or another personal item of the user.

30. A miniature subscriber terminal as claimed in claim 27, wherein the miniature subscriber terminal is also connectable via data transmission means to communicate over a data transmission connection with the separate data processor and the control means receive user's private data from the separate data processor and transmit user's private data to the separate data processor and the user's private data includes at least one of the following: health data of the user, exercise data of the user, beauty parlour data of the user, appointment data concerning services booked by the user.
